(19) United States
(12) Patent Application Publication
(10) Pub. No.: US 2026/0300900 A1
(43) Pub. Date: Oct. 1, 2026

(54) PLAN GENERATION APPARATUS, PLAN GENERATION METHOD, AND NON-TRANSITORY COMPUTER-READABLE MEDIUM

(71) Applicant: NEC Corporation, Tokyo (JP)

(72) Inventors: Shota KURIHARA, Tokyo (JP); Kei TAKEMURA, Tokyo (JP)

(73) Assignee: NEC Corporation, Tokyo (JP)

(21) Appl. No.: 19/564,554

(22) Filed: Mar. 12, 2026

(30) Foreign Application Priority Data
Mar. 25, 2025 (JP) 2025-050449

(51) Int. Cl. G06Q 10/083

(52) U.S. Cl. CPC G06Q 10/08355

(57) ABSTRACT

A plan generation apparatus includes an acquisition unit for acquiring an assignment plan representing a plan to assign a plurality of packages to a plurality of transporters, and a plan generation unit for generating a change plan representing a plan for assigning a package assigned to a first transporter in the assignment plan to another transporter among the plurality of transporters.

### INCORPORATION BY REFERENCE

This application is based upon and claims the benefit of priority from Japanese patent application No. 2025-050449, filed on Mar. 25, 2025, the disclosure of which is incorporated herein in its entirety by reference.

### TECHNICAL FIELD

The present disclosure relates to a plan generation apparatus that generates an assignment plan of a package to a transporter in distribution.

### BACKGROUND ART

Techniques for preparing a delivery plan for efficiently delivering package by truck or motorcycle have been developed. JP 2022-170815 A describes a technique that makes it possible to prepare a delivery plan that only requires a small number of vehicles to be used at high speed.

### SUMMARY

However, in the technique described in JP 2022-170815 A, if a condition unique to a case to be satisfied in delivery becomes complicated, efficiency of repeated optimization processing may become poor.

An example object of the present disclosure is to solve the above problems and create a more efficient plan for reducing the number of transporters by assigning a package of one transporter to another transporter.

A plan generation apparatus according to an example aspect of the present disclosure includes an acquisition unit for acquiring an assignment plan representing a plan to assign a plurality of packages to a plurality of transporters, and a plan generation unit for generating a change plan representing a plan for assigning a package assigned to a first transporter in the assignment plan to another transporter among the plurality of transporters.

A plan generation method according to an example aspect of the present disclosure includes acquiring an assignment plan representing a plan to assign a plurality of packages to a plurality of transporters, and generating a change plan representing a plan for assigning a package assigned to a first transporter in the assignment plan to another transporter among the plurality of transporters.

A plan generation program according to an example aspect of the present disclosure is a plan generation program for causing a computer to function as a plan generation apparatus, the program causing the computer to function as an acquisition means for acquiring an assignment plan representing a plan to assign a plurality of packages to a plurality of transporters, and a plan generation means for generating a change plan representing a plan for assigning a package assigned to a first transporter in the assignment plan to another transporter among the plurality of transporters.

According to the present disclosure, it is possible to create a more efficient plan for reducing the number of transporters by assigning a package of one transporter to another transporter.

### BRIEF DESCRIPTION OF THE DRAWINGS

FIG. 1 is a block diagram illustrating a configuration of a plan generation apparatus according to the present disclosure;

FIG. 2 is a flowchart illustrating a flow of a plan generation method according to the present disclosure;

FIG. 3 is a block diagram illustrating a configuration of a plan generation system according to the present disclosure;

FIG. 4 is an image diagram of an exemplary vehicle operation plan before being optimized by an annealing machine;

FIG. 5 is an image diagram after the vehicle operation plan of FIG. 4 is optimized by the annealing machine;

FIG. 6 is a flowchart illustrating a flow of a plan generation method serving as a scheduler of the plan generation system according to the present disclosure;

FIG. 7 illustrates an example of creating a combination of packages of equal to or less than two;

FIG. 8 is an image diagram illustrating whether each combination of packages in FIG. 7 can be inserted into a truck A;

FIG. 9 is an image diagram listing candidates in which the order of carrying the packages is fixed;

FIG. 10 is a flow for determining whether all three constraint conditions are satisfied for each package in each candidate in which the order of packages is fixed;

FIG. 11 is a flow illustrating details of a constraint check of FIG. 10;

FIG. 12 is a flow of optimization processing of the plan generation system according to the present disclosure; and

FIG. 13 is a block diagram illustrating a hardware configuration of a computer that functions as each of the above apparatuses.

### EXAMPLE EMBODIMENT

Hereinafter, example embodiments of the present disclosure will be exemplified. However, the present disclosure is not limited to each of the exemplary example embodiments described below, and various modifications can be made within a scope described in the claims. For example, example embodiments obtained by appropriately combining techniques (some or all of things or methods) adopted in each of the exemplary example embodiments described below can also be included in the scope of the present disclosure. Example embodiments obtained by appropriately omitting some of the techniques adopted in each of the exemplary example embodiments described below can also be included in the scope of the present disclosure. In addition, effects mentioned in each of the exemplary example embodiments described below are examples of effects expected in the exemplary example embodiments, and do not define the extension of the present disclosure. That is, example embodiments that do not provide the effects mentioned in each of the exemplary example embodiments described below can also be included in the scope of the present disclosure.

### First Example Embodiment

A first exemplary example embodiment that is an example of the example embodiments of the present disclosure will be described in detail with reference to the drawings. The present exemplary example embodiment is a basic form of each exemplary example embodiment to be described later. An application range of each technique adopted in the present exemplary example embodiment is not limited to the present exemplary example embodiment. That is, each technique adopted in the present exemplary example embodiment can also be adopted in other exemplary example embodiments included in the present disclosure as long as no particular technical problem occurs. Each technique illustrated in the drawings referred to for explaining the present exemplary example embodiment can also be employed in other exemplary example embodiments included in the present disclosure as long as no particular technical problem occurs.

### (Configuration of Plan Generation Apparatus 1)

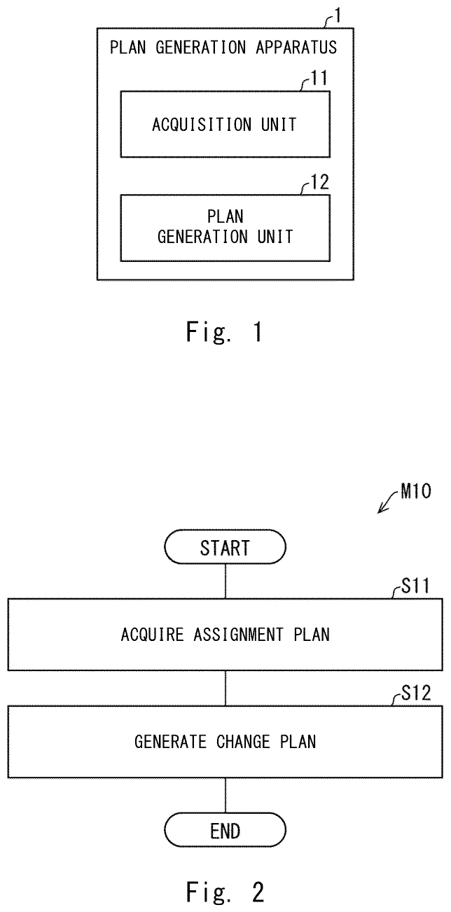

A configuration of a plan generation apparatus 1 according to the present exemplary example embodiment will be described with reference to FIG. 1. As illustrated in FIG. 1, the plan generation apparatus 1 includes an acquisition unit (means) 11 and a plan generation unit (means) 12.

### (Acquisition Unit 11)

The acquisition unit 11 acquires an assignment plan representing a plan for assigning a plurality of packages to a plurality of transporters. Here, the transporter is assumed to be a vehicle, a ship, an airplane, a drone, or the like.

### (Plan Generation Unit 12)

The plan generation unit 12 generates a change plan representing a plan for assigning the package assigned to a first transporter in the assignment plan to another transporter among the plurality of transporters. Here, the first transporter is a transporter on a deletion target side that unloads package, and the other transporter is a transporter on a side into which package is inserted.

### (Effects of Plan Generation Apparatus 1)

As described above, the plan generation apparatus 1 adopts a configuration of including
an acquisition unit for acquiring an assignment plan representing a plan for assigning a plurality of packages to a plurality of transporters, and
a plan generation unit for generating a change plan representing a plan for assigning a package assigned to a first transporter in the assignment plan to another transporter among the plurality of transporters.

As described above, since the plan generation apparatus 1 adopts a configuration of
generating a change plan representing a plan for assigning a package assigned to a first transporter in the assignment plan to another transporter among the plurality of transporters, it is possible to create a more efficient plan for reducing the number of transporters by assigning the package of one transporter to another transporter.

### (Flow of Plan Generation Method M10)

Next, a flow of the plan generation method M10 according to the present exemplary example embodiment will be described with reference to FIG. 2. FIG. 2 is a flowchart illustrating a flow of a plan generation method M10. The plan generation method M10 includes step S11 of acquiring an assignment plan and step S12 of generating a change plan.

### (Step S11)

In step S11, the acquisition unit 11 acquires an assignment plan representing a plan for assigning a plurality of packages to a plurality of transporters.

### (Step S12)

Subsequently, in step S12, the plan generation unit 12 generates a change plan representing a plan for assigning the package assigned to the first transporter in the assignment plan to another transporter among the plurality of transporters.

### (Effect of Plan Generation Method M10)

As described above, the plan generation method M10 adopts a configuration of
acquiring an assignment plan representing a plan for assigning a plurality of packages to a plurality of transporters, and
generating a change plan representing a plan for assigning a package assigned to a first transporter in the assignment plan to another transporter among the plurality of transporters. According to the above configuration, effects similar to those of the plan generation apparatus 1 are obtained.

### Second Example Embodiment

A second exemplary example embodiment that is an example of the example embodiments of the present disclosure will be described in detail with reference to the drawings. Components having the same functions as the components described in the above-described exemplary example embodiment are denoted by the same reference signs, and the description thereof will be appropriately omitted. An application range of each technique adopted in the present exemplary example embodiment is not limited to the present exemplary example embodiment. That is, each technique adopted in the present exemplary example embodiment can also be adopted in other exemplary example embodiments included in the present disclosure as long as no particular technical problem occurs. Each technique illustrated in each of the drawings referred to for description of the present exemplary example embodiment can be employed in the other exemplary example embodiments included in the present disclosure within a range in which no particular technical problem occurs.

### (Configuration of Plan Generation System 100)

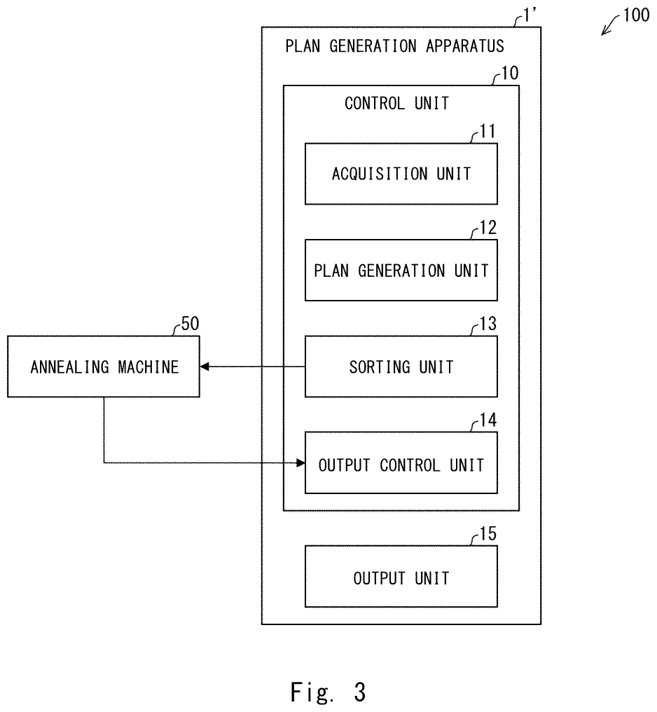

A configuration of a plan generation system 100 according to the present exemplary example embodiment will be described with reference to FIG. 3.

As illustrated in FIG. 3, the plan generation system 100 includes a plan generation apparatus 1′ and an annealing machine 50. The plan generation apparatus 1′ and the annealing machine 50 are communicably connected via a Local Area Network (LAN), a communication network, or the like. The annealing machine 50 is a vector calculator on which a pseudo quantum annealing method is implemented or a quantum computer on which a quantum annealing method is implemented. The annealing machine 50 is not limited to a vector calculator and a quantum computer, and may be a parallel calculator, a graphic board, or the like.

A sorting unit 13 to be described later is configured to cause the annealing machine to select (calculate) a desired change plan from among the change plans by using evaluation values (chartered vehicle cost, number of vehicles used, profit, etc.) regarding delivery of a plurality of packages. Here, the evaluation value may be the sum of the chartered vehicle cost of each vehicle used in the delivery plan. Alternatively, it can also be said that the sorting unit 13 performs processing of calculating an evaluation value with respect to the change plan and controls the annealing machine in such a way as to select a desired change plan from among the change plans.

Alternatively, it can also be said that the sorting unit 13 inputs the information indicating the change plan and the processing of calculating the evaluation value to the annealing machine, thereby transmitting a command instructing the annealing machine to select a desired change plan from among the change plans. In this case, the annealing machine performs processing of calculating the evaluation value on the data representing the input change plan, specifies a plan having the highest evaluation value among the plurality of change plans, and outputs the specified plan to the plan generation apparatus 1′. By performing the processing in this manner, an effect is obtained in that the calculation processing amount in the annealing machine can be reduced.

The change plan is represented by assignment information (insertion candidate matrix to be described later) including an identifier (package combination ID (C0, C1 . . . ) to be described later, see FIG. 11) representing a combination of packages assigned to a plurality of transporters (first transporters) to be reduced and information representing whether the combination is assigned to another transporter. The annealing machine selects the desired change plan by using the evaluation value related to the assignment information.

### (Configuration of Plan Generation Apparatus 1′)

A configuration of a plan generation apparatus 1′ according to the present exemplary example embodiment will be described with reference to FIG. 3.

As illustrated in FIG. 3, the plan generation apparatus 1′ includes a control unit 10 and an output unit 15. The control unit 10 includes an acquisition unit (means) 11, a plan generation unit (means) 12, a sorting unit (means) 13, and an output control unit 14.

### (Plan Generated by Plan Generation System 100)

The plan generation system 100 is for reducing the number of vehicles by inserting a package of one vehicle (trucks, motorcycles, etc.) into another vehicle based on the planned existing vehicle operation plan, and in particular, solves with which combination of vehicles a package is to be inserted to reduce the number of vehicles to be used the most by using the pseudo quantum annealing. Here, “insertion” means moving a package of one vehicle to another vehicle. All the candidate vehicles into which packages can be inserted are listed in advance.

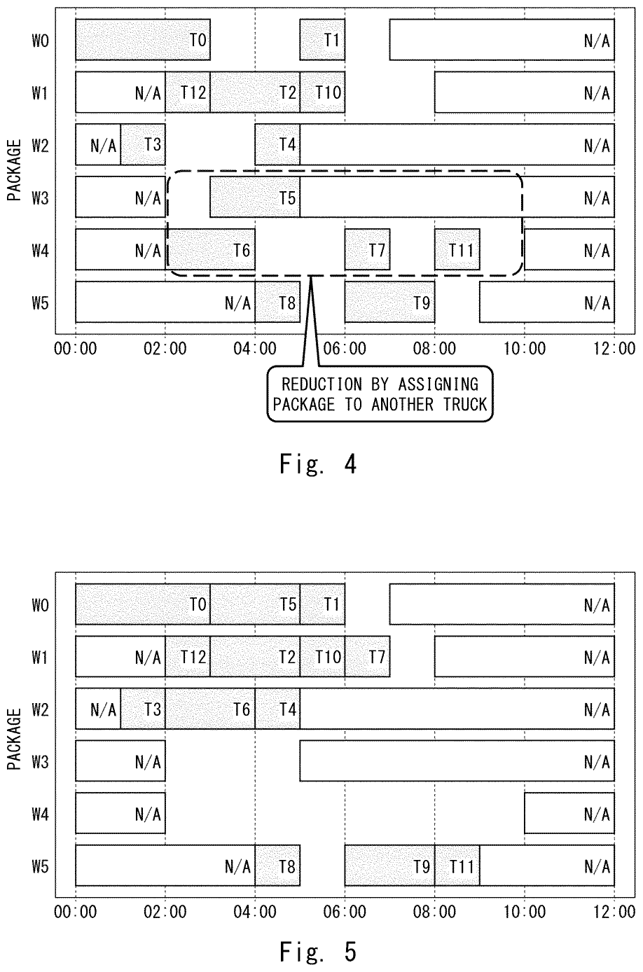

FIG. 4 is an image diagram of an exemplary vehicle operation plan before being optimized by the annealing machine 50, and FIG. 5 is an image diagram after the vehicle operation plan of FIG. 4 is optimized by the annealing machine 50. In this figure, the vehicle is defined as a worker (W), and the package is defined as a task (T). Here, it is assumed that six workers (W0 to W5) perform 13 tasks (T0 to 12) in the morning of a certain day.

The plan generation system 100 generates, as a result, a plan for assigning the task T5 of the worker W3 to the worker W0, the task T6 of the worker W4 to the worker W2, the task T7 of the worker W4 to the worker W1, and the task T11 of the worker W4 to the worker W5. As a result, the workers W3 and W4 are unnecessary, and the number of vehicles to be used is reduced.

As described above, the plan generation system 100 is constructed as a simulator that estimates how many more vehicles to be used can be reduced with respect to the existing vehicle operation plan. Alternatively, for example, it may be a scheduler that changes and updates the operation plan in such a way that the package that has cut in is inserted into the master plan on a daily basis with respect to the master plan created on a monthly basis.

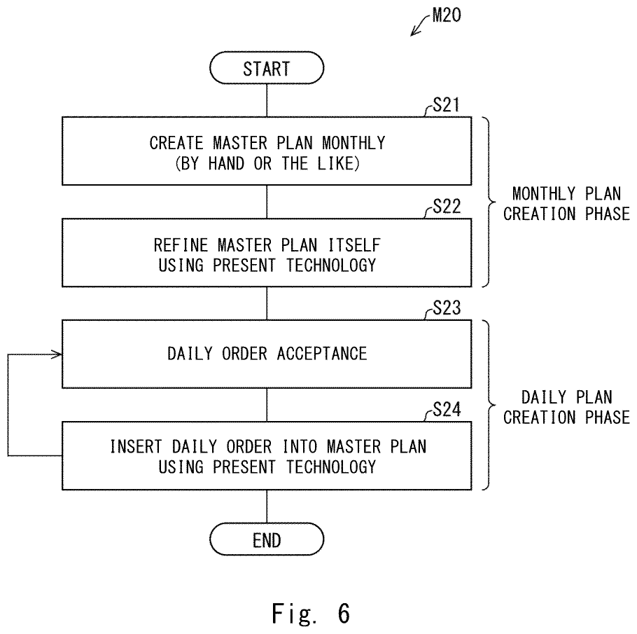

FIG. 6 is a flowchart illustrating a flow of a plan generation method M20 serving as a scheduler of the plan generation system 100. As the monthly plan creation phase, for example, a monthly master plan is manually created in step S21. Then, in step S22, the acquisition unit 11 of the plan generation apparatus 1′ acquires the master plan, and the plan generation unit 12 generates a plan for changing (refining) the master plan.

Next, as the daily plan creation phase, in step S23, the acquisition unit 11 acquires (accepts) a daily additional order. Then, in step S24, the plan generation unit 12 generates a plan for adding (inserting) the daily additional order to the master plan. Naturally, step S24 may be performed on a daily basis, and step S22 may be performed on a monthly basis. In other words, the plan generation unit 12 creates a plurality of change plans (insertion candidate matrices to be described later).

As described above, the monthly master plan and the daily additional order related to the assignment plan are manually created in steps S21 and S23, and the plan generation unit 12 generates a plan for changing (improving) the plan and the order in steps S22 and S24.

### (Three Constraint Conditions)

There are three constraint conditions regarding the input data from the sorting unit 13 to the annealing machine 50.

<Constraint Condition 1: Constraint Regarding Base where Loading/Unloading is Performed>

### Vehicle Type

There are constraints regarding a vehicle type (tonnage) that can enter each base (Base 1, Base 2, Base 3, etc.). The vehicle type may be, for example, the maximum loading capacity of the vehicle, the weight of the vehicle, or the size of the vehicle.

### Entry Possible Time

Depending on the base, there is also a constraint regarding the time at which the vehicle can enter each base in such a way that the vehicle cannot enter until after what time in the early morning.

### <Constraint Condition 2: Constraint Regarding Vehicle>

### Operable Time of Vehicle

It is assumed that ±X minutes from the movement time of the vehicle of the record (deliverable solution (e.g., an existing vehicle operation plan)) is the operable time. This ±X minutes take into consideration the carry-in and carry-out work time of the package.

### Break Time

A break time related to the operation time of the truck is set. For example, in a case where the operation time of the vehicle is equal to or longer than 6.0 hours, it is necessary to take a break of equal to or longer than 1.0 hours for the driver, and in a case where the operation time is shorter than 6.0 hours, a condition such as that it is not necessary to take a break for the driver or the like is considered.

### Fixed Time Window

In some time windows, there may be vehicles with fixed movement (i.e., the above-described task).

There are constraints regarding a time during which each vehicle can be operated, such as an operable time of the vehicle, a break time, and a fixed time window.

### Number of Packages

The number of packages that can be loaded is limited for each vehicle.

Package Weight (ton)

The package weight (ton) that can be loaded is limited for each vehicle. There are constraints regarding the package that can be delivered by each vehicle, such as the number of packages and the package weight.

### Vehicle Penalty

In a case where the vehicle is used even for one minute, a service vehicle fee is generated (chartered vehicle cost). Here, the term “chartered vehicle” refers to a vehicle in which a transport delivery operation undertaken by a certain transportation company is requested to a driver of another transportation company or an individual business operator or in which a transport delivery operation is requested.

### <Constraint Condition 3: Constraint Regarding Package Deliverable by Vehicle>

### Delivery Possible Time

The time required for loading and unloading is kept within a range of +Y hours from the recorded delivery time. Here, Y has detailed conditions depending on the type of package. The type of package is, for example, whether temperature management is necessary, the period until the expiration date, or the like.

### Delivery Route Fixed Package

Some packages must be carried in a particular vehicle (e.g., piano conveyance in a special truck).

### Work Time Constraint

As an example, the work time proportional to the number of packages to be loaded/unloaded at the work base is considered. However, the work time constraint can be freely set as long as the work time can be derived by the combination of the work base and the package to be loaded/unloaded.

### Movement Time Constraint

The movement time between the bases is given in a matrix format in advance. Even in the movement between the same bases, the movement time varies between daytime, early morning, and late night. The delivery deadline is also considered.

### (Acquisition Parameter of Plan Generation Apparatus)

The acquisition unit 11 of the plan generation apparatus 1′ acquires, as input parameters, a list of packages, a list of vehicles, a list of bases, a list of movement times between the bases, and the like. Here, in the list of packages, loading and unloading are recorded as separate records. The two need to be linked by a column called a package ID. That is, a package with the same package ID needs to be delivered by the same vehicle (common ID is held for loading and unloading). An exemplary data structure of the package list is shown in Table 1.

### (Exemplary Data Structure of Package List)

TABLE 1

| | | | LOADING/ | LOADING/ | | PACKAGE | |
|---|---|---|---|---|---|---|---|
| PACKAGE | LOAD/ | BASE | UNLOADING | UNLOADING | NUMBER OF | WEIGHT | VEHICLE |
| ID | UNLOAD | CODE | START TIME | END TIME | PACKAGES | (TON) | ID |
| 0001 | LOAD | BASE 1 | 8:00 | 8:15 | 4 | 1 | 1 |
| 0002 | UNLOAD | BASE 1 | 15:45 | 16:00 | 8 | 2 | 2 |
| 0001 | UNLOAD | BASE 2 | 9:00 | 9:15 | 4 | 1 | 1 |
| 0002 | LOAD | BASE 3 | 15:00 | 15:15 | 8 | 2 | 2 |

Furthermore, an exemplary data structure of the vehicle list is illustrated in Table 2.

### (Exemplary Data Structure of Vehicle List)

TABLE 2

| | | | | LOAD- |
|---|---|---|---|---|
| | CHARTERED | OPERATION | OPERATION | ABLE |
| VEHICLE | VEHICLE | START | END | WEIGHT |
| ID | CHARGE | TIME | TIME | (TON) |
| 1 | 20000 | 8:00 | 12:00 | 4 |
| 2 | 10000 | 13:00 | 20:00 | 2 |

Furthermore, an exemplary data structure of the base list is illustrated in Table 3.

### (Exemplary Data Structure of Base List)

TABLE 3

| BASE | ENTRY POSSIBLE | ENTRY POSSIBLE |
|---|---|---|
| CODE | TONNAGE | TIME |
| BASE 1 | 10 | 5:00 |
| BASE 2 | 6 | 5:30 |
| BASE 3 | 4 | |
| . . . | | |

In addition, an exemplary data structure of the list of movement time between bases is illustrated in Table 4.

### (Exemplary Data Structure of List of Movement Time Between Bases)

TABLE 4

| | BASE 1 | BASE 2 | BASE 3 | . . . |
|---|---|---|---|---|
| BASE 1 | — | 10 | 8 | |
| BASE 2 | 10 | — | 15 | |
| BASE 3 | 8 | 15 | — | |
| . . . | | | | |

### (Selection of Vehicle to be Deleted)

The plan generation unit 12 selects a vehicle to be reduced. Specifically, a vehicle in which the load capacity is small or in which loading packages with respect to the maximum load capacity is small is selected. The plan generation unit 12 selects, as a vehicle to be reduced, a first transporter that satisfies (i.e., smaller than one threshold value) a criterion indicating that the number or amount of assigned packages is small in the assignment plan. This makes it possible to more efficiently reduce the number of transporters.

Alternatively/additionally, a transporter having a possibility of carrying few packages while making a detour may be reduced. That is, the plan generation unit 12 may select, as the vehicle to be deleted, a first transporter that satisfies other criteria (greater than other threshold values) indicating that the ratio of the operation time of the first transporter with respect to the number or amount of the assigned package is large in the assignment plan. This makes it possible to further reduce the number of transporters more efficiently.

### (Creation of Insertion Candidate Matrix)

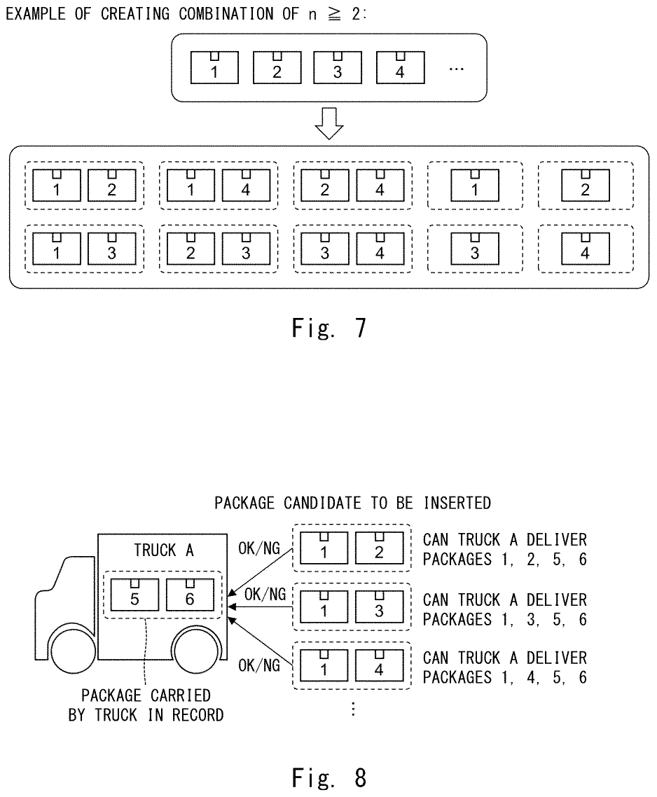

The plan generation unit 12 creates, as an insertion candidate matrix, a combination of equal to or less than n pieces of package for all the packages included in the vehicle to be reduced described above. Here, a vehicle having a delivery route fixed package is not a reduction target. FIG. 7 illustrates an example of creating a combination of packages of n≥2. The insertion candidate matrix partially corresponds to the change plan of the first example embodiment described above.

As illustrated in the figure, “package 1, package 2”, “package 1, package 4”, “package 2, package 4”, “package 1, package 3”, “package 2, package 3”, and “package 3, package 4” are created as combinations (n=2) of two packages, and “package 1”, “package 2”, “package 3”, and “package 4” are created as single packages (n=1).

The sorting unit 13 sorts whether such a combination of packages can be inserted into each vehicle. FIG. 8 is an image diagram illustrating whether each combination of packages in FIG. 7 can be inserted into the vehicle (truck) A. Here, the truck A is already loaded with the packages 5 and 6 in the records.

Then, the sorting unit 13 determines whether the packages 1 and 2, the packages 1 and 3, the packages 1 and 4, and the like can be inserted into the truck A based on the above-described three constraint conditions. As long as these constraint conditions are satisfied, the order of delivering the packages may be changed such that for example, the packages 1 and 2 are delivered first before the packages 5 and 6 are delivered to the destination.

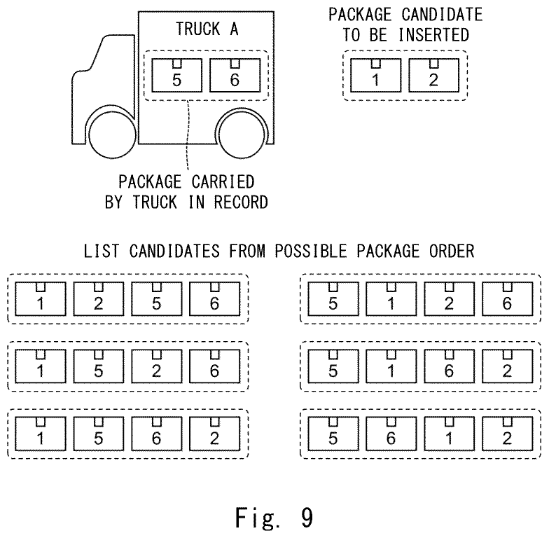

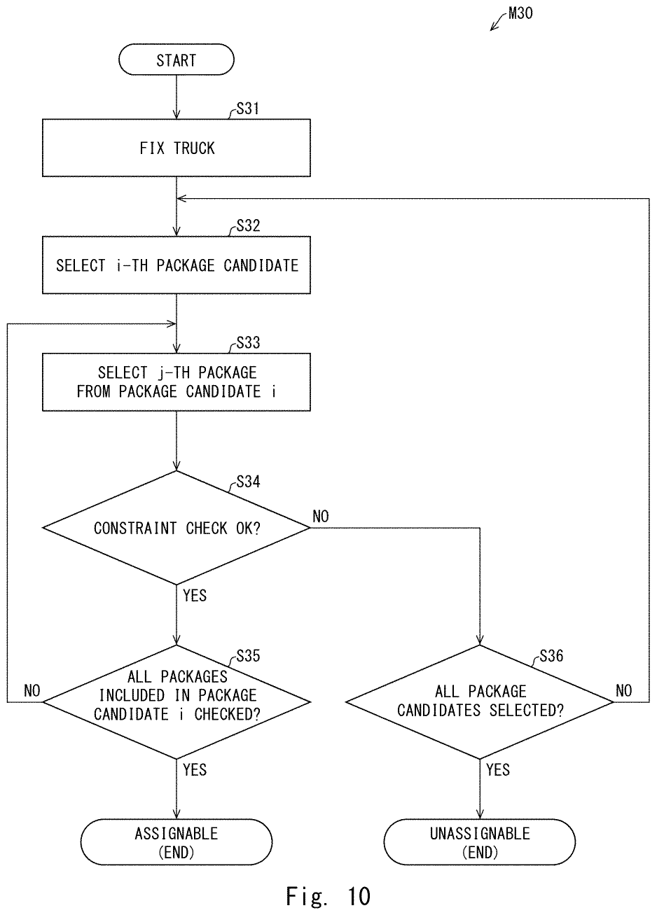

FIG. 9 is an image diagram listing candidates in which the order of carrying the packages is fixed. As illustrated in the drawing, the sorting unit 13 combines the packages 5 and 6 carried by the truck in the record with the package candidates (here, the packages 1 and 2) to be inserted, and lists the candidates in which the order of carrying the packages is fixed. Here, candidates in which the order of loading (insertion) and unloading (record) is reversed are not listed.

In other words, the plan generation unit 12 creates the change plan in such a way as to maintain the order of the packages assigned to a plurality of other transporters. By maintaining the order of the packages in this manner, the delivery person can efficiently perform the delivery.

As the candidates, “packages 1, 2, 5, 6”, “packages 1, 5, 2, 6”, “packages 1, 5, 6, 2”, “packages 5, 1, 2, 6”, “packages 5, 1, 6, 2”, and “packages 5, 6, 1, 2” are listed. The sorting unit 13 determines whether each candidate in which the order of the packages is fixed in this manner satisfies all of the above-described three constraint conditions. In a case where even one of these candidates satisfies all three constraint conditions, the sorting unit 13 determines that there is a candidate to which the packages 1 and 2 can be assigned.

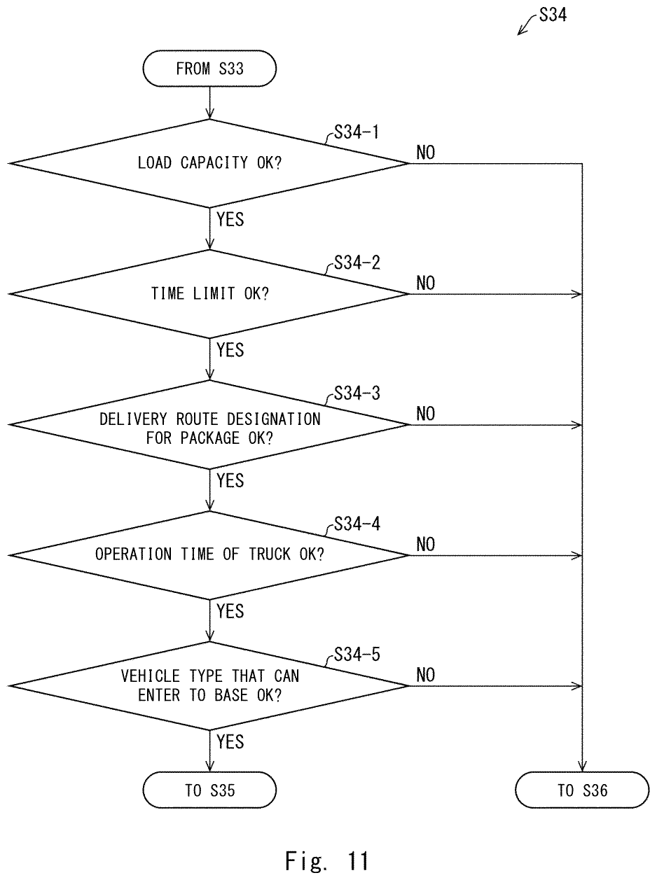

This determination processing is illustrated in FIG. 10. FIG. 10 is a flow M30 for determining whether all three constraint conditions are satisfied for each package in each candidate in which the order of packages is fixed.

In the first step S31, the sorting unit 13 fixes the truck to be determined (e.g., focus on truck A). Thereafter, in step S32, the sorting unit 13 selects a combination of i-th package candidates (e.g., if 1≤i≤6 and i=1, “packages 1, 2, 5, 6”). Thereafter, in step S33, the sorting unit 13 selects the j-th package from the i-th package candidate (in this case, if 1≤j≤4 and j=2, “package 2”). Thereafter, in step S34, the sorting unit 13 determines whether all three constraint conditions are satisfied as a constraint check.

FIG. 11 is a flow illustrating details of a constraint check S34 of FIG. 10. In step S34-1, the sorting unit 13 determines whether the load capacity of the truck A does not exceed the upper limit (corresponding to the number of packages and the package weight (tons) of the vehicle constraint of the constraint condition 2 described above). In the case of “Yes”, the processing proceeds to step S34-2, and in the case of “No”, the processing proceeds to step S36.

In step S34-2, the sorting unit 13 adds the working time and the movement time to the destination and determines whether the time constraint is not exceeded (corresponding to delivery possible time, working time constraint, and movement time of constraint condition 3, and vehicle penalty of constraint condition 2 described above). In the case of “Yes”, the processing proceeds to step S34-3, and in the case of “No”, the processing proceeds to step S36.

In step S34-3, the sorting unit 13 determines whether the package has been subjected to the delivery route designation (corresponding to the fixed time window of the constraint condition 2 and the delivery route fixed package of the constraint condition 3 described above). In the case of “Yes”, the processing proceeds to step S34-4, and in the case of “No”, the processing proceeds to step S36.

In step S34-4, the sorting unit 13 determines whether the truck A does not exceed the operation time constraint (corresponding to the entry possible time of the constraint condition 1 described above and the operable time and the break time of the vehicle of the constraint condition 2). In the case of “Yes”, the processing proceeds to step S34-5, and in the case of “No”, the processing proceeds to step S36.

In step S34-5, the sorting unit 13 determines whether the vehicle type that can enter the base is exceeded (corresponding to the vehicle type of the constraint condition 1 described above). If “yes”, the sorting unit 13 proceeds to step S35. If “no”, the sorting unit 13 proceeds to step S36.

In step S35, the sorting unit 13 determines whether all the packages included in the package candidates i have been checked (e.g., if i=1, all the packages of packages 1, 2, 5, and 6). In the case of “Yes”, the sorting unit 13 determines that the package (e.g., package “1, 2”) can be assigned, and terminates the processing (processing completed).

In the case of “No”, the processing returns to step S33, and the next package (e.g., package 5) is selected to perform the constraint check. As described above, there is further a loop of j for picking up and determining each package in the package candidate in the loop of i.

In step S36, the sorting unit 13 determines whether all the package candidates have been checked (In FIG. 9, 1≤i≤6). If “Yes”, the sorting unit 13 determines that the package cannot be assigned and terminates the processing (processing completed). In the case of “No”, the processing returns to step S32, the next package candidate (e.g., “packages 1, 5, 2, 6”) is selected, and the processing proceeds to step S33.

In addition, a series of steps of steps S32 to S36 may be arbitrarily reordered/added/deleted, or each step (constraint condition 1 to 3) may also be arbitrarily changed/added/deleted. This makes it possible to respond to a wide range of determination processing patterns, constraint conditions, and the like.

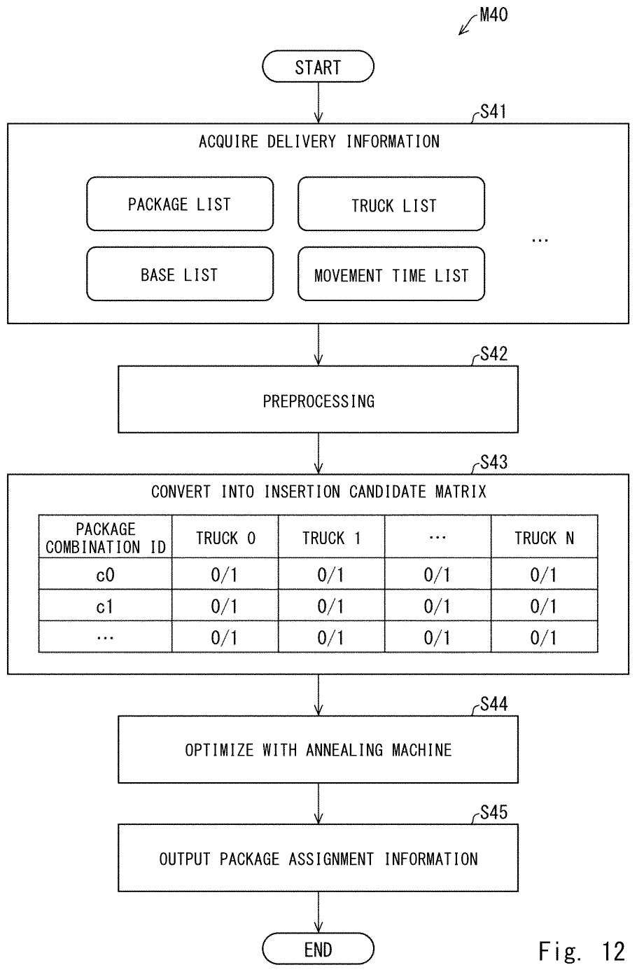

FIG. 12 illustrates a flow M40 of an optimization processing of the plan generation system 100 based on the above determination processing. In step S41, the acquisition unit 11 acquires delivery information. The delivery information includes the above-described package list (Table 1), vehicle list (Table 2), base list (Table 3), movement time list (Table 4), and the like.

Thereafter, in step S42, the plan generation unit 12 creates, as preprocessing, combinations of equal to or less than n pieces of package for all the packages included in the vehicle to be reduced. In other words, the number of packages to be assigned to other transporters is equal to or less than a predetermined number (n). As a result, the calculation efficiency can be enhanced by the sorting unit 13 making a determination on a combination of packages of a predetermined number or less. Then, the predetermined number is, for example, two, and the calculation efficiency of the plan generation apparatus 1′ is enhanced by making a determination on a combination of two or less packages.

Thereafter, in step S43, the sorting unit 13 sorts whether the combination of packages created in step S42 can be inserted into each vehicle, converts the sorting result into an insertion candidate matrix, and transmits the insertion candidate matrix to the annealing machine 50. In other words, the sorting unit 13 outputs a plan that satisfies the constraint condition at the time the package is delivered by the transporter among the plurality of created change plans. By satisfying the constraint condition, the plan generation apparatus 1′ can create a realistic change plan.

This insertion candidate matrix is, for example, a matrix obtained by binarizing the sorting results with the combination ID (C0, C1 . . . ) of the package as a row and N vehicles as a column, with the case where insertion is possible being “1” and the case where insertion is not possible being “0”.

Thereafter, in step S44, the annealing machine 50 optimizes the insertion candidate matrix created in step S43. The control unit 10 repeats steps S43 and S44 until the solution converges. The annealing machine 50 reassigns all packages of a certain vehicle to another vehicle having a lower chartered vehicle cost. That is, the annealing machine 50 changes all the packages delivered by one vehicle to be delivered by another vehicle in such a way that the evaluation value is improved.

This reduces the chartered vehicle cost

In addition, the annealing machine 50 may assign packages by integrating packages for two vehicles to another vehicle. That is, the annealing machine 50 may make a change in such a way that all the packages delivered by the two vehicles are delivered by another vehicle in such a way that the evaluation value is improved. This reduces the chartered vehicle cost

The annealing machine 50 transmits the optimization result in which the solution has converged to the output control unit 14. Thereafter, in step S45, the output control unit 14 outputs the result (package assignment information) to the output unit (e.g., the display) 15. Alternatively, the control unit 10 may control the operation of the vehicle based on the updated delivery plan.

The flow M40 of the optimization processing as described above is not limited to the input data and the constraint condition, and if conversion can be made into the insertion candidate matrix at the stage (step S43) of the preprocessing, the optimization of step S44 can be executed. That is, the flow M40 does not depend on the number, contents, and the like of the input data and the constraint conditions as long as the conditions can be considered only by the pair of the vehicle and the package. However, if it deviates from this consideration condition, there is a limited condition (e.g., a load waiting constraint at a berth (a place where a vehicle stops to load/unload a package)).

As described above, the plan generation system 100 acquires delivery information such as a package list and a vehicle list, creates a combination pattern of packages as preprocessing, sorts each combination of packages and insertion possibility with respect to each vehicle, and then inputs the sorting result to the quantum computer to optimize a solution. By feeding back this optimized solution to the existing vehicle operation plan, the delivery plan for reducing the chartered vehicle cost (in other words, the number of vehicles to be used) is more efficiently prepared.

### [Implementation Example by Software]

Some or all of the functions of the plan generation apparatuses 1 and 1′ (hereinafter, also referred to as “each of the above apparatuses”) may be achieved by hardware such as an integrated circuit (IC chip) or may be achieved by software.

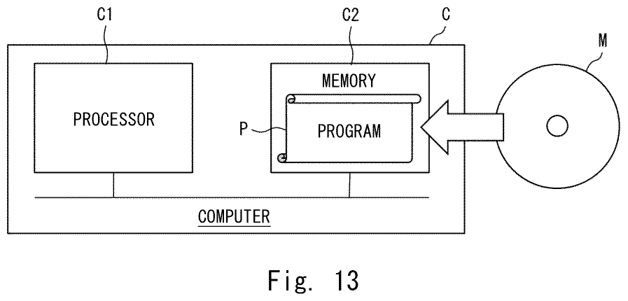

In the latter case, each of the above apparatuses is achieved by, for example, a computer that executes commands of a program that is software for implementing each function. An example of such a computer (hereinafter referred to as a computer C) is illustrated in FIG. 13. FIG. 13 is a block diagram illustrating a hardware configuration of the computer C that functions as each of the above apparatuses.

The computer C includes at least one processor C1 and at least one memory C2. A program P for causing the computer C to operate as each of the above apparatuses is recorded in the memory C2. In the computer C, by the processor C1 reading the program P from the memory C2 and executing the program P, each function of each of the above apparatuses is achieved.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination of these can be used. As the memory C2, for example, a flash memory, a Hard Disk Drive (HDD), a Solid State Drive (SSD), or a combination of these can be used.

The computer C may further include a Random Access Memory (RAM) for loading the program P at the time of execution and temporarily storing various types of data. The computer C may further include a communication interface for transmitting and receiving data to and from another apparatus. The computer C may further include an input/output interface for connecting input/output apparatuses such as a keyboard, a mouse, a display, and a printer.

The program P can be recorded on a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

### Supplementary Information A

The present disclosure includes the techniques described in the following Supplementary Notes. However, the present disclosure is not limited to the technologies described in the following Supplementary Notes, and various modifications can be made within the scope described in the claims.

### Supplementary Note A1

A plan generation apparatus including
an acquisition means for acquiring an assignment plan representing a plan to assign a plurality of packages to a plurality of transporters, and
a plan generation means for generating a change plan representing a plan for assigning a package assigned to a first transporter in the assignment plan to another transporter among the plurality of transporters.

### Supplementary Note A2

The plan generation apparatus according to supplementary note A1, further including a sorting unit, in which
the plan generation means creates a plurality of the change plans, and
the sorting unit outputs a plan that satisfies a constraint condition at the time a package is delivered by a transporter among the plurality of created change plans.

### Supplementary Note A3

The plan generation apparatus according to supplementary note A1, in which
there are a plurality of other transporters, and
the plan generation means creates the change plan to maintain order of the packages assigned to the other transporters.

### Supplementary Note A4

The plan generation apparatus according to supplementary note A1, in which the plan generation means selects, in the assignment plan, the first transporter that satisfies a criterion indicating that number or amount of the assigned packages is small.

### Supplementary Note A5

The plan generation apparatus according to supplementary note A1, in which the plan generation means selects, in the assignment plan, the first transporter that satisfies a criterion indicating that a ratio of an operation time of the first transporter with respect to the number or amount of the assigned packages is large.

### Supplementary Note A6

The plan generation apparatus according to supplementary note A1, further including a sorting unit for causing an annealing machine to select a desired change plan from among the change plans by using an evaluation value related to delivery of the plurality of packages, in which
the first transporter is a plurality of transporters to be reduced,
the change plan is represented by assignment information including an identifier representing a combination of packages assigned to the plurality of transporters to be reduced and information representing whether the combination is assigned to the other transporters, and
the annealing machine selects the desired change plan by using the evaluation value related to the assignment information.

### Supplementary Note A7

The plan generation apparatus according to supplementary note A1, in which the number of packages to be assigned to the other transporters is equal to or less than a predetermined number.

### Supplementary Note A8

The plan generation apparatus according to supplementary note A4, in which the predetermined number is two.

### Supplementary Note A10

A plan generation program for causing a computer to function as a plan generation apparatus, the program causing the computer to function as
an acquisition means for acquiring an assignment plan representing a plan to assign a plurality of packages to a plurality of transporters, and
a plan generation means for generating a change plan representing a plan for assigning a package assigned to a first transporter in the assignment plan to another transporter among the plurality of transporters.

### Supplementary Information B

The present disclosure includes the techniques described in the following Supplementary Notes. However, the present disclosure is not limited to the technologies described in the following Supplementary Notes, and various modifications can be made within the scope described in the claims.

### Supplementary Note B1

A plan generation method including
acquisition processing in which at least one processor acquires an assignment plan representing a plan to assign a plurality of packages to a plurality of transporters, and
plan generation processing in which the at least one processor generates a change plan representing a plan for assigning a package assigned to a first transporter in the assignment plan to another transporter among the plurality of transporters.

### Supplementary Note B2

The plan generation method according to supplementary note B1, further including a sorting processing, in which
in the plan generation processing, the at least one processor creates a plurality of the change plans, and
the sorting processing outputs a plan that satisfies a constraint condition at the time a package is delivered by a transporter among the plurality of created change plans.

### Supplementary Note B3

The plan generation method according to supplementary note B1, in which
there are a plurality of other transporters, and
in the plan generation processing, the at least one processor creates the change plan to maintain order of the packages assigned to the other transporters.

### Supplementary Note B4

The plan generation method according to supplementary note B1, in which in the plan generation processing, the at least one processor selects, in the assignment plan, the first transporter that satisfies a criterion indicating that number or amount of the assigned packages is small.

### Supplementary Note B5

The plan generation method according to supplementary note B1, in which in the plan generation processing, the at least one processor selects, in the assignment plan, the first transporter that satisfies a criterion indicating that a ratio of an operation time of the first transporter with respect to the number or amount of the assigned packages is large.

### Supplementary Note B6

The plan generation method according to supplementary note B1, further including a sorting processing for causing an annealing machine to select a desired change plan from among the change plans by using an evaluation value related to delivery of the plurality of packages, in which
the first transporter is a plurality of transporters to be reduced,
the change plan is represented by assignment information including an identifier representing a combination of packages assigned to the plurality of transporters to be reduced and information representing whether the combination is assigned to the other transporters, and
the annealing machine selects the desired change plan by using the evaluation value related to the assignment information.

### Supplementary Note B7

The plan generation method according to supplementary note B1, in which the number of packages to be assigned to the other transporters is equal to or less than a predetermined number.

### Supplementary Note B8

The plan generation method according to supplementary note B4, in which the predetermined number is two.

### Supplementary Note B10

A plan generation program for causing a computer to function as a plan generation apparatus, the program causing the computer to function as
acquisition processing in which the at least one processor acquires an assignment plan representing a plan to assign a plurality of packages to a plurality of transporters, and
plan generation processing in which the at least one processor generates a change plan representing a plan for assigning a package assigned to a first transporter in the assignment plan to another transporter among the plurality of transporters.

### Supplementary Information C

The present disclosure includes the techniques described in the following Supplementary Notes. However, the present disclosure is not limited to the technologies described in the following Supplementary Notes, and various modifications can be made within the scope described in the claims.

### Supplementary Note C1

A plan generation program for causing a computer to function as a plan generation apparatus, the program causing the computer to function as
an acquisition means for acquiring an assignment plan representing a plan to assign a plurality of packages to a plurality of transporters, and
a plan generation means for generating a change plan representing a plan for assigning a package assigned to a first transporter in the assignment plan to another transporter among the plurality of transporters.

### Supplementary Note C2

The plan generation program according to supplementary note C1, further including a sorting unit, in which
the plan generation means creates a plurality of the change plans, and
the sorting means outputs a plan that satisfies a constraint condition at the time a package is delivered by a transporter among the plurality of created change plans.

### Supplementary Note C3

The plan generation program according to supplementary note C1, in which
there are a plurality of other transporters, and
the plan generation means creates the change plan to maintain order of the packages assigned to the other transporters.

### Supplementary Note C4

The plan generation program according to supplementary note C1, in which the plan generation means selects, in the assignment plan, the first transporter that satisfies a criterion indicating that number or amount of the assigned packages is small.

### Supplementary Note C5

The plan generation program according to supplementary note C1, in which the plan generation means selects, in the assignment plan, the first transporter that satisfies a criterion indicating that a ratio of an operation time of the first transporter with respect to the number or amount of the assigned packages is large.

### Supplementary Note C6

The plan generation program according to supplementary note C1, further including a sorting means for causing an annealing machine to select a desired change plan from among the change plans by using an evaluation value related to delivery of the plurality of packages, in which
the first transporter is a plurality of transporters to be reduced,
the change plan is represented by assignment information including an identifier representing a combination of packages assigned to the plurality of transporters to be reduced and information representing whether the combination is assigned to the other transporters, and
the annealing machine selects the desired change plan by using the evaluation value related to the assignment information.

### Supplementary Note C7

The plan generation program according to supplementary note C1, in which the number of packages to be assigned to the other transporters is equal to or less than a predetermined number.

### Supplementary Note C8

The plan generation program according to supplementary note C4, in which the predetermined number is two.

### Supplementary Note C10

A plan generation program for causing a computer to function as a plan generation apparatus, the program causing the computer to function as
an acquisition means for acquiring an assignment plan representing a plan to assign a plurality of packages to a plurality of transporters, and
plan generation processing of generating a change plan representing a plan for assigning a package assigned to a first transporter in the assignment plan to another transporter among the plurality of transporters.

### Supplementary Information D

The present disclosure includes the techniques described in the following Supplementary Notes. However, the present disclosure is not limited to the technologies described in the following Supplementary Notes, and various modifications can be made within the scope described in the claims.

### Supplementary Note D1

A plan generation apparatus including at least one processor, the at least one processor executing
acquisition processing of acquiring an assignment plan representing a plan to assign a plurality of packages to a plurality of transporters, and
plan generation processing of generating a change plan representing a plan for assigning a package assigned to a first transporter in the assignment plan to another transporter among the plurality of transporters.

The plan generation apparatus may further include a memory. The memory may store a program for causing the at least one processor to execute each of the processing.

### Supplementary Note D2

The plan generation apparatus according to supplementary note D1, further including a sorting unit, in which
in the plan generation processing, the at least one processor creates a plurality of the change plans, and
the sorting unit outputs a plan that satisfies a constraint condition at the time a package is delivered by a transporter among the plurality of created change plans.

### Supplementary Note D3

The plan generation apparatus according to supplementary note D1, in which
there are a plurality of other transporters, and
in the plan generation processing, the at least one processor creates the change plan to maintain order of the packages assigned to the other transporters.

### Supplementary Note D4

The plan generation apparatus according to supplementary note D1, in which in the plan generation processing, the at least one processor selects, in the assignment plan, the first transporter that satisfies a criterion indicating that number or amount of the assigned packages is small.

### Supplementary Note D5

The plan generation apparatus according to supplementary note D1, in which in the plan generation processing, the at least one processor selects, in the assignment plan, the first transporter that satisfies a criterion indicating that a ratio of an operation time of the first transporter with respect to the number or amount of the assigned package is large.

### Supplementary Note D6

The plan generation apparatus according to supplementary note D1, further including a sorting unit for causing an annealing machine to select a desired change plan from among the change plans by using an evaluation value related to delivery of the plurality of packages, in which
the first transporter is a plurality of transporters to be reduced,
the change plan is represented by assignment information including an identifier representing a combination of packages assigned to the plurality of transporters to be reduced and information representing whether the combination is assigned to the other transporters, and
the annealing machine selects the desired change plan by using the evaluation value related to the assignment information.

### Supplementary Note D7

The plan generation apparatus according to supplementary note D1, in which the number of packages to be assigned to the other transporters is equal to or less than a predetermined number.

### Supplementary Note D8

The plan generation apparatus according to supplementary note D4, in which the predetermined number is two.

### Supplementary Note D10

A plan generation program for causing a computer to function as a plan generation apparatus, the program causing the computer to function as
acquisition processing of acquiring an assignment plan representing a plan to assign a plurality of packages to a plurality of transporters, and
plan generation processing of generating a change plan representing a plan for assigning a package assigned to a first transporter in the assignment plan to another transporter among the plurality of transporters.

### Supplementary Information E

The present disclosure includes the techniques described in the following Supplementary Note. However, the present disclosure is not limited to the technologies described in the following Supplementary Note, and various modifications can be made within the scope described in the claims.

### Supplementary Note E1

A non-transitory recording medium recording a plan generation program for causing a computer to function as a plan generation apparatus, the plan generation program causing the computer to function as
acquisition processing of acquiring an assignment plan representing a plan to assign a plurality of packages to a plurality of transporters, and
plan generation processing of generating a change plan representing a plan for assigning a package assigned to a first transporter in the assignment plan to another transporter among the plurality of transporters.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

1. A plan generation apparatus comprising:
at least one storage medium configured to store instructions; and
at least one processor configured to execute the instructions to:
acquire an assignment plan representing a plan to assign a plurality of packages to a plurality of transporters; and
generate a change plan representing a plan for assigning a package assigned to a first transporter in the assignment plan to another transporter among the plurality of transporters.

2. The plan generation apparatus according to claim 1, wherein the at least one processor is further configured to execute the instructions to:
create a plurality of the change plans, and
output, among the plurality of created change plans, a plan satisfying a constraint condition at the time of delivering a package by a transporter.

3. The plan generation apparatus according to claim 1, wherein
there are a plurality of other transporters, and
wherein the at least one processor is further configured to execute the instructions to:
create the change plan to maintain order of the packages assigned to the other transporters.

4. The plan generation apparatus according to claim 1, wherein the at least one processor is further configured to execute the instructions to:
select, in the assignment plan, the first transporter that satisfies a criterion indicating that number or amount of the assigned packages is small.

5. The plan generation apparatus according to claim 1, wherein the at least one processor is further configured to execute the instructions to:
select, in the assignment plan, the first transporter that satisfies a criterion indicating that a ratio of an operation time of the first transporter with respect to the number or amount of the assigned packages is large.

6. The plan generation apparatus according to claim 1, wherein the at least one processor is further configured to execute the instructions to:
cause an annealing machine to select a desired change plan from among the change plans by using an evaluation value related to delivery of the plurality of packages, and wherein
the first transporter is a plurality of transporters to be reduced,
the change plan is represented by assignment information including an identifier representing a combination of packages assigned to the plurality of transporters to be reduced and information representing whether the combination is assigned to the other transporters, and
the annealing machine selects the desired change plan by using the evaluation value related to the assignment information.

7. The plan generation apparatus according to claim 1, wherein the number of packages to be assigned to the other transporters is equal to or less than a predetermined number.

8. The plan generation apparatus according to claim 4, wherein the predetermined number is two.

9. A plan generation method comprising:
acquiring an assignment plan representing a plan to assign a plurality of packages to a plurality of transporters; and
generating a change plan representing a plan for assigning a package assigned to a first transporter in the assignment plan to another transporter among the plurality of transporters.

10. A non-transitory computer-readable medium that stores a plan generation program for causing a computer to function as a plan generation apparatus, the program causing the computer to execute:
acquiring an assignment plan representing a plan to assign a plurality of packages to a plurality of transporters; and
generating a change plan representing a plan for assigning a package assigned to a first transporter in the assignment plan to another transporter among the plurality of transporters.
